(19) United States
(12) Patent Application Publication
(10) Pub. No.: US 2002/0160715 A1
(43) Pub. Date: Oct. 31, 2002

(54) Post-amplification linearization

(76) Inventors: Michael S. Davis, Mountain View, CA (US); Alan R. Cherrette, Los Altos, CA (US)

Correspondence Address: Joyce Kosinski, Loral Space and Communications, Ltd., Suite 303, 655 Deep Valley Drive, Rolling Hills Estates, CA, 90274, US

(21) Appl. No.: 09/819,348

(22) Filed: Mar. 28, 2001

(51) Int. Cl. H04B 1/10

(52) U.S. Cl. 455/63; 455/295; 455/296; 375/296; 375/346

(57) ABSTRACT

A post-amplification linearization technique for processing a signal distorted by a nonlinear amplifier. The post-amplification linearization technique is implemented using a linearizer and linearization method and involves processing the distorted signal using nonlinear processing to reduce intermodulation distortion. The nonlinear processing reduces the intermodulation distortion by applying an integral transformation to the nonlinear amplifier characteristic.

### BACKGROUND

The present invention relates generally to linearization of power amplifiers, and more particularly, to a post-amplification linearizer and linearization method.

The assignee of the present invention manufactures and deploys spacecraft into geosynchronous and low earth orbits. Such spacecraft carry communication equipment including transponders and power amplifiers. Linearizers have heretofore been developed that attempt to linearize such power amplifiers.

The closest previously known solution to linearization is pre-amplification linearizer. For example, U.S. Pat. No. 5,789,978, issued Aug. 4, 1998, entitled “Ku-Band Linearizer Bridge”, U.S. Pat. No. 5,999,047, issued Dec. 7, 1999, entitled “Linearizer for use with Power Amplifiers”, U.S. Pat. No. 5,966,049, issued Oct. 12, 1999, entitled “Broadband linearizer for power amplifiers”, and U.S. patent application Ser. No. 09/433,128, filed Nov. 3, 1999 entitled “Low Cost Miniature Broadband Linearizer”, all of which are assigned to the assignee of the present invention, disclose various linearizers for use with power amplifiers. In pre-amplification linearizers, the linrearizing function is performed just before high power amplification. However, there are no known prior art linearizers that are used for post-amplification linearization.

Accordingly, it is an objective of the present invention to provide for a post-amplification linearizer and post-amplification linearization method.

### SUMMARY OF THE INVENTION

To accomplish the above and other objectives, the present invention provides for post-amplification linearization of a signal that has been distorted by a nonlinear amplifier. The post-amplification linearization technique is implemented in a linearizer and linearization method involves processing a signal that has been distorted by the nonlinear amplifier using nonlinear processing that reduces intermodulation distortion. The nonlinear processing that reduces the intermodulation distortion is obtained by applying an integral transformation to the nonlinear amplifier characteristic.

The linearizing function in the post-amplification linearizer and linearization method is performed after high power amplification. For example, on a communications spacecraft, traveling wave tube amplifiers operated in saturation distort the transmitted signal producing intermodulation distortion. A post-amplification linearizer located in a receiving terminal at a ground station reduces the intermodulation distortion in the received signal.

The present invention greatly reduces intermodulation distortion in transmitted signals while allowing efficient amplifier operation. Reduction in intermodulation distortion provides better signal to noise ratios, which allows increase data rates. Reduction in intermodulation distortion will also allow the use of more bandwidth efficient modulation formats that conserve bandwidth.

### BRIEF DESCRIPTION OF THE DRAWINGS

The various features and advantages of the present invention may be more readily understood with reference to the following detailed description taken in conjunction with the accompanying drawing, wherein like reference numerals designate like structural elements, and in which:

FIG. 1 is a block diagram that illustrates signal processing steps that implement an exemplary post-amplification linearizer in accordance with the principles of the present invention;

FIG. 2 shows a plot of RF output power as a function of RF input power for CW and band limited noise signals applied to a nonlinear amplifier; and

FIG. 3 is a flow diagram that illustrates an exemplary post-amplification linearization method in accordance with the principles of the present invention.

### DETAILED DESCRIPTION

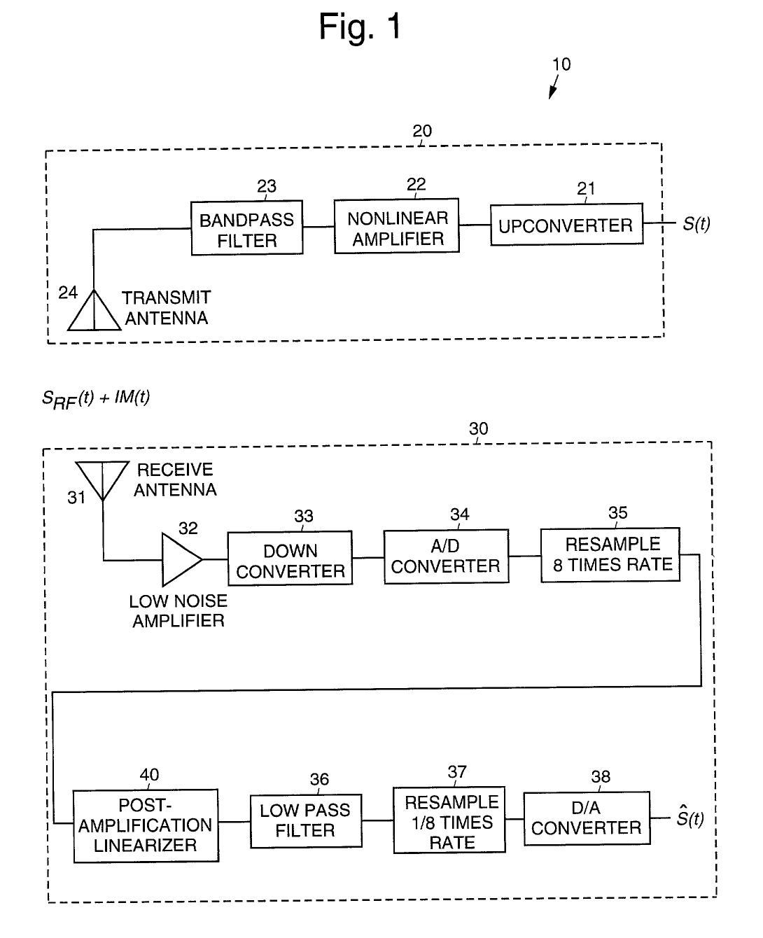

Referring to the drawing figures, FIG. 1 is a block diagram that illustrates signal processing steps that implement post-amplification linearization in accordance with the principles of the present invention. The example described herein is that of a digital implementation. However, other implementations such as analog, for example, are readily implemented using the principles of the present invention and will be discussed below.

As is shown in FIG. 1, a baseband signal, S(t), on a spacecraft 10, for example, is processed by a transmitter 20. The transmitter 20 comprises an upconverter 21, a nonlinear amplifier 22, such as a high power traveling wave tube amplifier 22, a bandpass filter 23, and a transmit antenna 24. The transmitter 20 transmits a signal comprising an RF signal and intermodulation distortion, illustrated in FIG. 1 as the signal S_{RF}(t)+IM(t).

This signal is transmitted to a ground station receiver 30 or receive terminal 30 which comprises a receive antenna 31, low noise amplifier 32, downconverter 33, analog to digital (A/D) converter 34 resampling circuit 35 (8 times rate), a post-amplification linearizer 40 in accordance with the present invention, a low pass filter 36, a resampling circuit 37 (⅛ times rate), and a digital to analog (D/A) converter 38. The output of the receiver 30 or receive terminal 30 is an estimate of the baseband signal, Ŝ(t).

The signal processing steps in FIG. 1 are well understood by those skilled in the art. These processing steps involve transmission of the baseband signal S(t) over a free space link from the transmitter 20 to the receiver 30. The receiver 30 digitally processes the received signal to produce an estimate of S(t) that has reduced intermodulation distortion. The estimate of S(t) is the signal Ŝ(t). Nonlinear amplification is generally used to maximize the efficiency of the transmitting nonlinear amplifier 12.

The key to the present invention is the post-amplification linearizer 40 shown in FIG. 1. The signal processing performed in the post-amplification linearizer 40 involves taking each time sample of the input digitized signal and adjusting its amplitude according to a nonlinear transfer characteristic R(u), where u is the amplitude of the input signal for a given time sample and R(u) is the amplitude of the output signal for the same time sample.

The only assumption for the signal S(t) is that it has the amplitude statistics of band limited Gaussian white noise. The linearizing function R(u) can be calculated from the nonlinear transfer characteristic of the nonlinear amplifier. A mathematical definition of the function R(u) is given below.

As mentioned above, the post amplification linearization process does not have to be implemented digitally but may be implemented in an analog circuit, provided the nonlinear function R(u) can be produced with enough accuracy. In the analog case, all processing steps or blocks between and including the A/D and D/A converters 34, 38 shown in FIG. 1 are replaced by an analog version of the post-amplification linearizer 40.

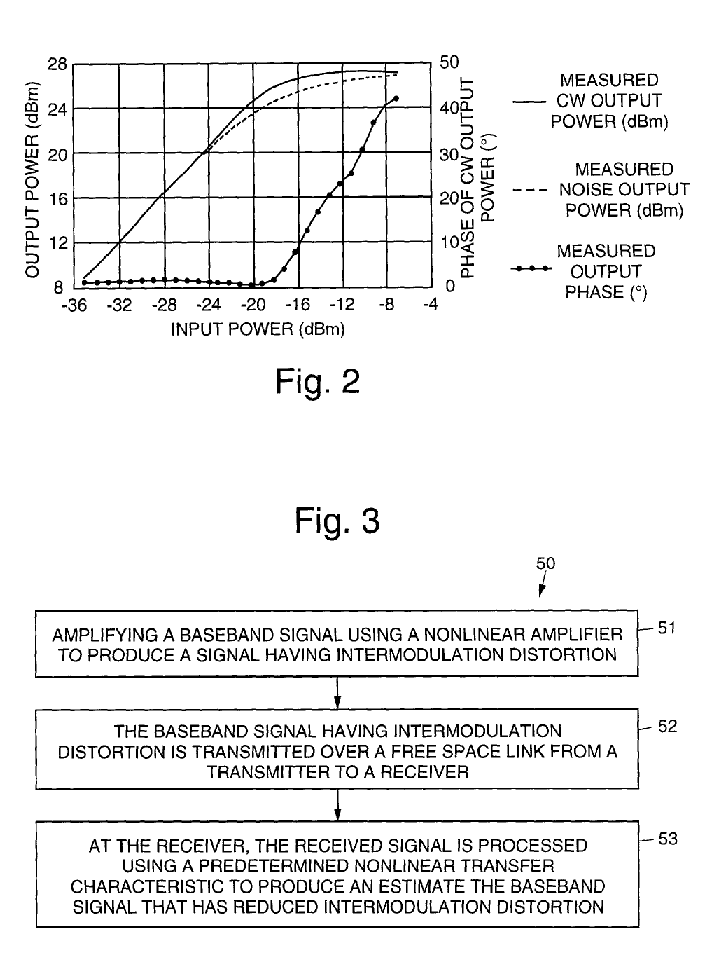

FIG. 2 shows a plot of RF output power as a function of RF input power for CW and band limited noise signals applied to a nonlinear amplifier, such as the nonlinear amplifier 22 in the transmitter 20. The functional relationship of output power to input power is different for a bandlimited noise signal than it is for a CW signal.

FIG. 2 shows plots of RF output power as a function of RF input power for a CW signal (solid line) and a noise signal (dashed line) applied to the nonlinear amplifier 22. Also shown is a plot of RF output phase as a function of RF input power for a CW signal (solid line with dots).

The functional relationship, shown in FIG. 2 of CW signal output power and CW signal output phase to input power may be written as:

$${P}_{out} ( {P}_{in} ) = 1 / {2 [ U ( {P}_{in} ) ]}^{2} + 1 / {2 [ V ( {P}_{in} ) ]}^{2} = {[ W ( {P}_{in} ) ]}^{2} and \\ θ ( {P}_{in} ) = arctan [ U ( {P}_{in} ) / [ V ( {P}_{in} ) ] ] \qquad ( 1 )$$

where:

Aₒᵤₜ=W(Pᵢₙ)·cos[(ω·t+θ(Pᵢₙ)]

=W(Pᵢₙ)·cos[θ(Pᵢₙ)]·cos[ω·t]−W(Pᵢₙ)·sin[θ(Pᵢₙ)]·sin[ω·t]

=U(Pᵢₙ)·cos[ω·t]−V(Pᵢₙ)·sin[ω·t].

The in-phase (I) and quadrature (Q) components of the CW output power functional relationship may be defined as follows:

Pₒᵤₜ(Pᵢₙ)=Pₒᵤₜ_{_{—}}_{I}(Pᵢₙ)+Pₒᵤₜ_{_{—}}_{Q}(Pᵢₙ) (2)

where

Pₒᵤₜ_{_{—}}_{I}(Pᵢₙ)=½[U(Pᵢₙ)]² and Pₒᵤₜ_{_{—}}_{Q}(Pᵢₙ)=½[V(Pᵢₙ)]².

The quantities above can be calculated from the measured CW data shown in FIG. 2.

It can be shown that the bandlimited noise signal output power plus intermodulation product output power is given by:

$${P}_{out\_noise + IM} ( {P}_{in\_noise} ) = {\int }_{0}^{∞} {P}_{out\_I} ( x ) \cdot [ ( 1 / {P}_{in\_noise} ) \cdot {ⅇ}^{( - x / {P}_{in\_noise} )} ] ⅆ x + {\int }_{0}^{∞} {P}_{out\_Q} ( x ) \cdot [ ( 1 / {P}_{in\_noise} ) \cdot {ⅇ}^{( - x / {P}_{in\_noise} )} ] ⅆ x \\ = {\int }_{0}^{∞} {P}_{out} ( x ) \cdot [ ( 1 / {P}_{in\_noise} ) \cdot {ⅇ}^{( - x / {P}_{in\_noise} )} ] ⅆ x \qquad ( 3 )$$

Let the function F(x) be the inverse of the noise signal plus intermodulation product output power function of noise signal input power. The function F(x) is defined mathematically as:

Pᵢₙ_{_{—}}ₙₒᵢₛₑ=F[Pₒᵤₜ_{_{—}}ₙₒᵢₛₑ_{_{—}}_{IM}(Pᵢₙ_{_{—}}ₙₒᵢₛₑ)]. (4)

In Equation (4), the function F(x) represents power and the argument x also represents power. The post-amplification linearizing function implemented in the post-amplification linearizer 40 is defined as a voltage function in the following way:

R(u)=\sqrt{F(u²)} for u≧0, and R(u)=−\sqrt{F(u²)} for u<0. (5)

FIG. 3 is a flow diagram that illustrates an exemplary post-amplification linearization method 50 in accordance with the principles of the present invention. The exemplary post-amplification linearization method 50 comprises the following steps.

A baseband signal is amplified 51 by a nonlinear amplifier 22 to produce a signal having intermodulation distortion. The baseband signal having intermodulation distortion is transmitted 52 over a free space link from a transmitter 20 to a receiver 30. At the receiver 30, the received signal is processed 53 using a predetermined nonlinear transfer characteristic to produce an estimate the baseband signal that has reduced intermodulation distortion.

In processing the received signal, it is time sampled and its amplitude is adjusted according to the predetermined nonlinear transfer characteristic R(u), where u is the amplitude of the received signal for a given time sample and R(u) is the amplitude of the output signal for the same time sample. The linearizing function R(u) is calculated from the nonlinear transfer characteristic of the nonlinear amplifier.

Post-amplification linearization implemented in accordance with the present invention greatly reduces intermodulation distortion, which improves Noise Power Ratio (NPR). Preliminary measured results indicate that a transmitted signal with an NPR=11.9 dB can be improved to an NPR=17.0 dB using the present post amplification linearization technique. This is far greater than the <1.0 dB improvement obtained by preamplification linearization for an amplifier driven to the equivalent output power.

Thus, a post-amplification linearizer for use with power amplifiers along with a post-amplification linearization method have been disclosed. It is to be understood that the above-described embodiments are merely illustrative of some of the many specific embodiments that represent applications of the principles of the present invention. Clearly, numerous and other arrangements can be readily devised by those skilled in the art without departing from the scope of the invention.

What is claimed is:

1. Apparatus comprising:
a transmitter for amplifying a baseband signal using a nonlinear amplifier to produce a signal having intermodulation distortion and for transmitting the signal over a free space link;
a receiver for receiving the transmitted signal having intermodulation distortion and for processing it using a predetermined nonlinear transfer characteristic to produce an estimate the baseband signal that has reduced intermodulation distortion.

2. The apparatus recited in claim 1 wherein the transmitter comprises:
an upconverter;
a nonlinear amplifier;
a bandpass filter; and
a transmit antenna.

3. The apparatus recited in claim 1 wherein the nonlinear amplifier comprises a high power traveling wave tube amplifier.

4. The apparatus recited in claim 1 wherein the receiver comprises:
a receive antenna;
a low noise amplifier;
a downconverter;
an analog to digital (A/D) converter;
a resampling circuit;
a post-amplification linearizer that processes the signal using the predetermined nonlinear transfer characteristic;
a low pass filter;
a resampling circuit; and
a digital to analog (D/A) converter that outputs the estimate of the baseband signal.

5. The apparatus recited in claim 1 wherein the predetermined nonlinear transfer characteristic is given by:
R(u)=\sqrt{F(u²)} for u≧0, and R(u)=−\sqrt{F(u²)} for u<0,
where F(u) the inverse of the noise signal plus intermodulation product output power function of noise signal input power and u is the amplitude of the input signal for a given time sample.

6. The apparatus recited in claim 5 wherein the signal S(t) has amplitude statistics of band limited Gaussian white noise.

7. A post-amplification linearization method comprising the steps of:
amplifying a baseband signal to produce a signal having intermodulation distortion;
transmitting the signal having intermodulation distortion over a free space link;
receiving the transmitted signal;
processing the received signal using a predetermined nonlinear transfer characteristic to produce an estimate the baseband signal that has reduced intermodulation distortion.

8. The method recited in claim 7 wherein the predetermined nonlinear transfer characteristic is given by:
R(u)=\sqrt{F(u²)} for u≧0, and R(u)=−\sqrt{F(u²)} for u<0,
where F(u) the inverse of the noise signal plus intermodulation product output power function of noise signal input power and u is the amplitude of the input signal for a given time sample.

9. The method recited in claim 8 wherein the signal S(t) has amplitude statistics of band limited Gaussian white noise.
